(19) United States
(12) Patent Application Publication
(10) Pub. No.: US 2010/0237635 A1
(43) Pub. Date: Sep. 23, 2010

(54) DOOR HANDLE APPARATUS FOR VEHICLE

(75) Inventors: Kiyokazu IEDA, Kariya-shi (JP); Eiji Mushiake, Chita-gun (JP)

Correspondence Address: BUCHANAN, INGERSOLL & ROONEY PC, POST OFFICE BOX 1404, ALEXANDRIA, VA, 22313-1404, US

(73) Assignee: AISIN SEIKI KABUSHIKI KAISHA, Kariya-shi (JP)

(21) Appl. No.: 12/724,568

(22) Filed: Mar. 16, 2010

(30) Foreign Application Priority Data
Mar. 18, 2009 (JP) 2009-065697

(51) Int. Cl. E05B 3/00; E05B 47/00; H01Q 1/32

(52) U.S. Cl. 292/336.3; 343/713

(57) ABSTRACT

A door handle apparatus for a vehicle includes a door handle arranged at an outer surface of an outer panel and releasing a latch mechanism when the door handle is manually operated, and a detection unit arranged within the outer panel so as to face the door handle, the detection unit including an electrode mechanism, whose electrostatic capacitance changes when a portion of a body of a user is inserted between the door handle and the outer panel, so that an unlocking operation or a locking operation is executed by means of a lock mechanism on the basis of the change of the electrostatic capacitance, and including an antenna sending a request signal for identifying a portable device, to the portable device, carried by the user.

### CROSS REFERENCE TO RELATED APPLICATIONS

This application is based on and claims priority under 35 U.S.C. §119 to Japanese Patent Application 2009-065697, filed on Mar. 18, 2009, the entire content of which is incorporated herein by reference.

### TECHNICAL FIELD

This disclosure relates to a door handle apparatus for a vehicle.

### BACKGROUND DISCUSSION

According to a known door handle apparatus for a vehicle, disclosed in JP2007-254995A, first and second door handle members, made of resin, for configuring a handle are arranged at an outer panel. Electronic members, such as a sending antenna and an unlock electrode, are accommodated at an inside portion formed by the first and second handle members. According to such a configuration, when it is detected that an electrostatic capacitance between the unlock electrode and the outer panel changes, a door unlock signal is outputted. Further, a connector, which is provided at base portions of the first and second handle members, is connected to a wiring harness.

The door handle apparatus, disclosed in JP2007-254995A, configures a smart entry system. More specifically, the sending antenna, provided at an in-vehicle unit, sends a request code. The request code is received by a portable device, and the portable device sends a modulated signal. When the modulated signal is received by a receiving antenna, the in-vehicle unit executes a process for comparing an ID code, which is obtained from the signal sent from the portable device, and an ID code, which is memorized in a memory. When the ID code, which is obtained from the signal sent from the portable device, and the ID code, which is memorized in the memory matches, a lock-and-unlock signal circuit is activated. In a state where the lock-and-unlock signal circuit is being activated, when it is detected that an electrostatic capacitance between the unlock electrode and the outer panel changes, a door opening-and-closing mechanism is switched to a locking state or an unlocking state.

In summary, according to the door handle apparatus, disclosed in JP2007-254995A, a state, where a lock of a door is releasable, is established when a user, carrying the portable device, approaches the vehicle, the lock of the door is released when the user inserts his/her hand between the door handle and the outer panel, and the door is operated to open by the user pulling the door handle.

Further, according to another known door handle apparatus for a vehicle, disclosed in U.S. Pat. No. 6,239,693B1, a lever for configuring a handle is arranged at a panel so as to form a space between an outer surface of the panel and the lever, and first and second sensors are arranged so as to face the space. The first sensor emits a light signal in an infrared range and the like. The second sensor receives the light signal, emitted by the first sensor. When the second sensor detects that a user inserts his/her hand into the space, the second sensor sends a signal to an electronic control module.

Furthermore, according to another known door handle apparatus for a vehicle, disclosed in JP2006-328899A, an end cover and an escutcheon, each of which is formed into a recessed shape, are attached to the door panel in a manner where the end cover and the escutcheon are fitted to each other, and thereby a recessed portion is formed at the door panel. A door handle is pivotably provided at the recessed portion. The escutcheon is made of a magnetic permeable material. An antenna, communicating with a portable device, is accommodated in an antenna accommodating portion, formed at an inner surface (a surface facing an inner side of a door) of the end cover.

According to such a configuration, when the portable device is identified during a communication between the antenna and the portable device, a control means switches a lock mechanism into an unlocking state. Then, a door is operated to open by a user pulling the door.

However, in a configuration of, for example, JP2007-254995A, where the sensor is accommodated at the inside portion of the handle, it may be required, in order to attach the handle to a door panel, that a wire of the sensor and a wire of a lock unit, arranged at an inside portion of the door, are connected to each other by means of the connector and the like. In a case where an optical device is adapted, a power supply wire for the optical device may be necessary in addition to a power supply wire for the sensor. As a result, the number of the wires may increase, and a dimension of an opening portion, formed at the door panel so as to arrange the wires therein, may increase. Accordingly, strength of the door panel may be deteriorated.

Further, in a configuration where the handle is entirely moved relative to the door panel so as to mechanically release a latch of the door, the wires, which connect the latch to the sensor arranged at the inside portion of the handle, may need to include a flexibly deformable property, and an configuration for allowing a deformation of the wire may be required.

Thus, in a configuration where the sensor is accommodated in the handle, the assembly of the wires may become complicated, the number of processes may increase, and a process may be required to connect the wires to each other, at the time of manufacturing.

On the other hand, according to the configuration of, for example, U.S. Pat. No. 6,239,693B1, where the sensor is arranged at the door panel, the task for connecting the wire of the door panel side and the wire of the door handle side by means of the connector, may not be necessary, and accordingly a size of the opening portion, formed at the door panel so as to arrange the wires therein, may be decreased.

In order to arrange the sensor at the door panel, a member, to which the first and second sensors are attached, is fitted into an opening, formed at the panel, from the inside of the panel, and a cover is attached to the panel from the outside of the panel so as to cover the opening, formed at the panel.

A need thus exists for a door handle apparatus for a vehicle, which is not susceptible to the drawback mentioned above.

### SUMMARY

According to an aspect of this disclosure, a door handle apparatus for a vehicle includes a door handle arranged at an outer surface of an outer panel and releasing a latch mechanism when the door handle is manually operated, and a detection unit arranged within the outer panel so as to face the door handle, the detection unit including an electrode mechanism, whose electrostatic capacitance changes when a portion of a body of a user is inserted between the door handle and the outer panel, so that an unlocking operation or a locking operation is executed by means of a lock mechanism on the basis of the change of the electrostatic capacitance, and including an antenna sending a request signal for identifying a portable device, to the portable device, carried by the user.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a block circuit diagram illustrating a configuration of a door handle apparatus;

FIG. 2 is a partially cut side view illustrating a door handle;

FIG. 3 is a perspective view illustrating the door handle;

FIG. 4 is a cross-sectional view taken along line IV-IV in FIG. 1,

FIG. 5 is a flow chart illustrating an unlock control;

FIG. 6 is a flow chart illustrating a lock control;

FIG. 7 is a cross-sectional view illustrating the door handle according to another embodiment;

FIG. 8 is a cross sectional view taken along line VIII-VIII in FIG. 7; and

FIG. 9 is a perspective view illustrating an attachment configuration of a case according to another embodiment.

### DETAILED DESCRIPTION

An embodiment of a door handle apparatus for a vehicle (which will be referred to as a door handle apparatus hereinafter) will be described hereinafter with reference to the attached drawings.

### [Basic Configuration]

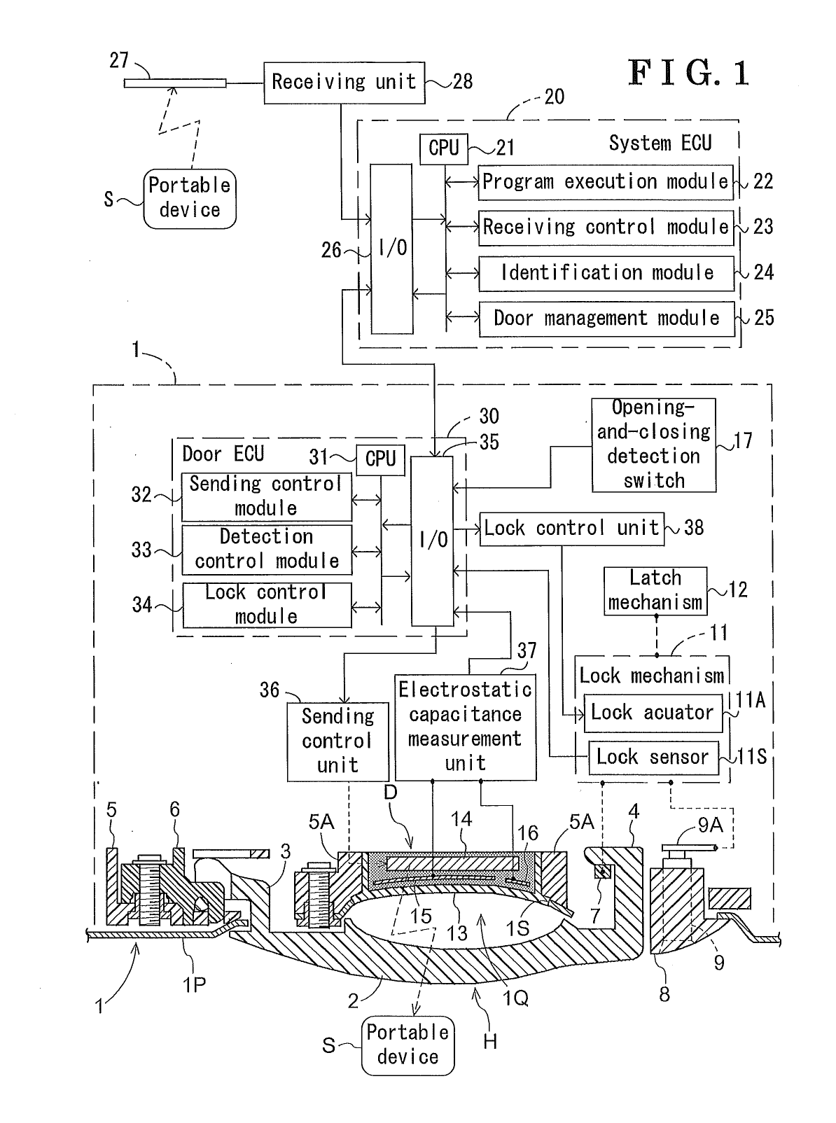

A door handle H for a vehicle (which will be referred to as a door handle H hereinafter) is provided at a door 1 of a vehicle, such as an automobile. As illustrated in FIGS. 1 to 4, the door handle apparatus is configured by the door handle H, which is supported at an outer panel 1P for forming an outer wall of the door 1, and by a detection unit D, which is arranged at a back surface (an inside of the door 1) of the outer panel 1P. Further, the door handle apparatus includes a sensor unit for detecting, for example, a hand of a user and the like, inserted into a recessed portion 1Q (described later), in order to execute a locking operation by means of a lock mechanism 11 provided at the door.

The door 1 includes an inner panel for forming an inner wall of the door 1 (a wall defining a vehicle interior). The inner panel together with the outer panel 1P configures a door panel. The lock mechanism 11 is provided at a spaced portion, generated between the inner panel and the outer panel 1P (which will be referred to as an inside portion of the door 1 hereinafter).

The door handle apparatus includes a locking system configured by a combination of a system ECU 20, which is provided at a vehicle body, and units, which are provided at the inside portion of the door 1. The locking system executes a wireless communication with a portable device S, carried by the user, in order to identify the portable device S, detects whether an unlocking command or a locking command is sent to the vehicle by the user, and executes the locking and unlocking operation of the door 1 on the basis of the detection of the locking and unlocking commands. Although the locking system may be applied to one or more of the door handles H, respectively, the following description will refer to a case where the locking system is applied to only one door handle H. The “ECU” in the description represents an “Electronic Control Unit”.

[Door Handle Apparatus]

As illustrated in FIG. 1, the door handle H is integrally configured by a grip portion 2, which is formed into a substantially longitudinal shape and which the user grabs/pulls with his/her hand, a hinge portion 3, which is formed at one longitudinal end of the grip portion 2, and an arm portion 4, which is formed at the other longitudinal end of the grip portion 2. The door handle H is attached to the outer panel so that the grip portion 2 substantially aligns with an outer surface of the outer panel 1P. The hinge portion 3 is engaged with a supporting member 6 of a door frame 5, provided at the inside portion of the outer panel 1P. The arm portion 4 is positioned to be contactable with a release piece 7, provided at the inner side of the outer panel 1P. According to such configuration, when the user manually pulls the grip portion 2, the arm portion 4 is moved outwardly with respect to the outer panel 1P in a manner of pivoting about a point where the hinge portion 3 is engaged with the supporting member 6. Accordingly, the release piece 7 is displaced, and a latch mechanism 12 is moved so as to open the door 1.

The hinge portion 3 and the arm portion 4 are respectively inserted into two openings formed at the outer panel 1P. Further, a door cap 8 is provided at the outer surface of the outer panel 1P so as to be adjacent to the arm portion 4 of the door handle H. The door cap 8 includes a key cylinder 9 used for manually opening or closing the door 1 by means of a key.

The release piece 7 is mechanically connected to the lock mechanism 11, provided at the inside portion of the door 1, while a rotational arm 9A of the key cylinder 9 is also mechanically connected to the lock mechanism 11. Further, the lock mechanism 11 is mechanically connected to the latch mechanism 12, provided at the inside portion of the door 1. The rotational arm 9A of the key cylinder 9 is rotated only when a corresponding key is inserted into the key cylinder 9 and the key is rotated therein.

The latch mechanism 12 is mechanically engaged with a striker and the like, provided at the vehicle body so as to protrude therefrom, thereby holding the door 1 in a closed state. The lock mechanism 11 is configured to be selectively switched between a locking state, in which an operational force, applied when the user manually operates the door handle H, is not transmitted to the latch mechanism 12, and an unlocking state, in which the operational force is transmitted to the latch mechanism 12. A manner of a locking operation and an unlocking operation by means of the lock mechanism 11 will be described later.

The lock mechanism 11 is selectively switched between the locking state and the unlocking state by means of an operational force, transmitted from the rotational arm 9A of the key cylinder 9. The lock mechanism 11 includes a lock actuator 11A, which actuates the locking operation and the unlocking operation. The lock actuator 11A is configured by an electric motor, an electromagnetic solenoid, and the like.

The recessed portion 1Q, which is recessed in a smoothly curved manner, is formed at a portion of the outer panel 1P corresponding to the grip portion 2. A clearance, generated between the recessed portion 1Q and the grip portion 2 so as to allow the user to insert his/her hand therein, serves as a work space.

A pair of sub frames 5A, connected to the door frame 5, are arranged at a back surface of the recessed portion 1Q (the inside portion of the door 1) so as to be adjacent to the two openings (described above). As illustrated in FIGS. 1 to 4, a slit 1S (an opening) whose width Ws in an upper-lower direction of the vehicle is set to be smaller than a width Wh of the grip portion 2 in the upper-lower direction of the vehicle, is formed at a portion of the outer panel 1P corresponding to the grip portion 2 when seen from a side of the outer panel 1P (in a direction perpendicular to a thickness direction of the door panel) so as to be arranged between the pair of the sub frames 5A. A length of the slit 1S in a horizontal direction of the vehicle is set to be longer than a length of the slit 1S in the upper-lower direction of the vehicle. The grip portion 2 of the door handle H is formed so as to extend longer than the slit 1S in the horizontal direction of the vehicle when the grip portion 2 is arranged in parallel with the slit 1S. The grip portion 2 is arranged so as to overlap longitudinal sides of the slit 1S in the horizontal direction.

A case 13, made of resin, is arranged in the slit 1S so that a portion of the case 13 is exposed to an outside of the door 1, and is supported thereat by the pair of sub frames 5A. The detection unit D is configured in such a manner that an LF antenna 14 (an antenna), an unlock detection electrode 15 and a lock detection electrode 16 are accommodated in the case 13. The LF antenna 14 is configured in a manner of winding a conductor around a ferrite bar so as to form a coil. Each of the unlock detection electrode 15 and the lock detection electrode 16 is made of a good conductor, such as a copper plate, a copper wire and the like. The unlock detection electrode 15 and the lock detection electrode 16 configure an electrode mechanism. The unlock detection electrode 15 and the lock detection electrode 16 are arranged in series with each other along a longitudinal direction of the vehicle.

The inner panel and the outer panel 1P of the door 1 are made of a steel plate. Therefore, the inner panel and the outer panel 1P serve as a shield against an electromagnetic wave. Accordingly, a radio wave, outputted from the LF antenna 14, is sent to an outside of the vehicle through the slit 1S. However, in a case where the outer panel 1P is made of resin, such as FRP and the like, the slit 1S may not be required.

[Locking System]

FIG. 1 schematically illustrates the locking system. The locking system includes the system ECU 20, serving as a core of control, at the vehicle body, and door ECUs 30 at the corresponding doors 1. The system ECU 20 includes a microprocessor unit (CPU) 21. The system ECU 20 further includes a program execution module 22 for executing a predetermined program, a receiving control module 23 for receiving a response signal, outputted from the portable device S, an identification module 24 for identifying the portable device S, a door management module 25 for managing the plurality of doors 1, and a first input-and-output interface 26. The system ECU 20 further includes a memory for memorizing a data temporally, a memory for memorizing a program, and a data bus for transmitting information, and the like.

A receiving unit 28 for receiving signals via a UHF antenna 27, provided at the vehicle body, is provided at the vehicle body. The signals, received by the receiving unit 28, are sent to the receiving control module 23. Each of the receiving control module 23, the identification module 24 and the door management module 25 is configured by software. Alternatively, each of the receiving control module 23, the identification module 24 and the door management module 25 may be configured by hardware or by a combination of software and hardware.

The door ECU 30 includes a microprocessor unit (CPU) 31. The door ECU 30 further includes a sending control module 32 for sending a request signal, a detection control module 33 for controlling a detection by means of the lock detection electrode 15 and the unlock detection electrode 16, a lock control module 34 for executing a locking operation and an unlocking operation by means of the lock mechanism 11, and a second input-and-output interface 35.

Each of the sending control module 32, the detection control module 33 and the lock control module 34 is configured by software. Alternatively, each of the sending control module 32, the detection control module 33 and the lock control module 34 may be configured by hardware or by a combination of software and hardware.

As described above, the lock mechanism 11 and the latch mechanism 12 are provided at the inside portion of the door 1. The lock mechanism 11 includes the lock actuator 11A for establishing the locking state and the unlocking state of the lock mechanism 11, and a lock sensor for detecting whether the lock mechanism 11 is in the locking state or in the unlocking state. An opening-and-closing detection switch 17 for detecting an opened state and a closed state of the door 1 is provided at the inside portion of the door 1.

Further, a sending control unit 36 for sending a radio wave signal from the LF antenna 14, and an electrostatic capacity measurement unit 37 for measuring an electrostatic capacity of each of the unlock detection electrode 15 and the lock detection electrode 16, and a lock control unit 38 are provided at the inside portion of the door 1.

A signaling system is established between the second input-and-output interface 35 of the door ECU 30 and each of the opening-and-closing detection switch 17, the lock actuator 11A, the lock sensor 11S, the sending control unit 36, the electrostatic capacitance measurement unit 37 and the lock control unit 38 so that information is transmitted therebetween.

Manner of Control]

According to the above described locking system, the unlocking operation is executed when the user is authorized on the basis of an identification of a user ID of the portable device S, such as a smart key and the like carried by the user, and subsequently, it is detected that the user, carrying the portable device S, inserts his/her hand into the clearance between the grip portion 2 of the door handle H and the outer panel 1P by the unlock detection electrode 15 in a non-contacting manner. On the other hand, the locking operation is actuated when the user opens the door 1 and closes the door 1 after getting out of the vehicle, and then it is detected that the user inserts his/her hand into the clearance between the grip portion 2 of the door handle H and the outer panel 1P by the lock detection electrode 16 in a non-contacting manner. Such control is performed in a manner where the program execution module 22 of the system ECU 20 executes the predetermined program, and the door ECU 30 executes a required control on the basis of information, inputted by the system ECU 20. An unlock control routine and a lock control routine corresponding to such control will be described hereinafter.

[Unlock Control Routine]

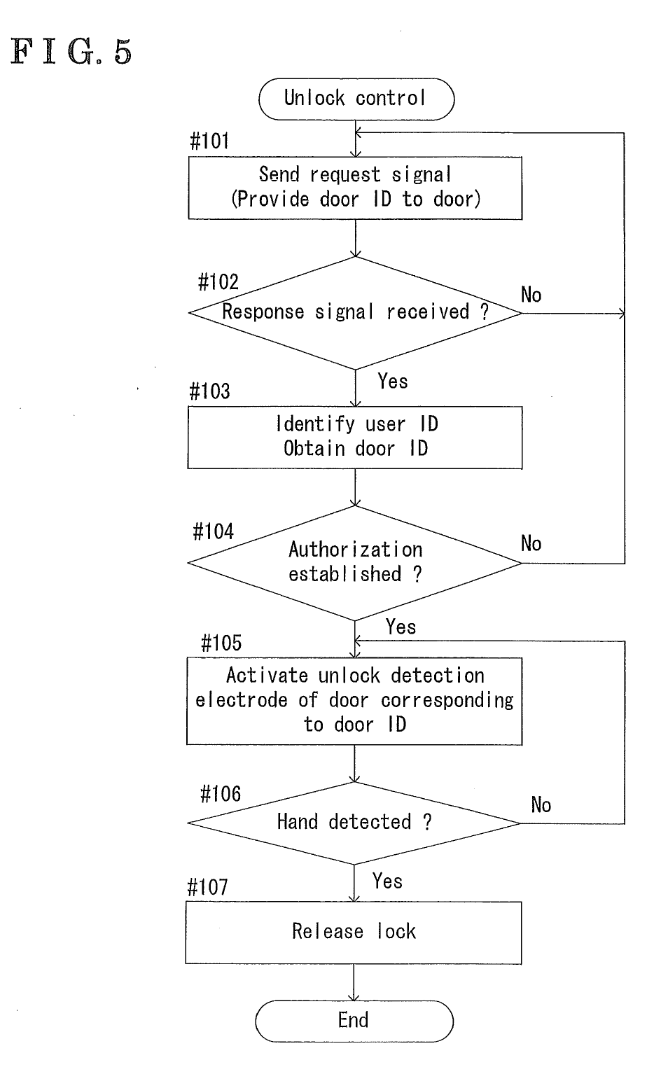

The unlock control routine is illustrated in a flowchart shown in FIG. 5. The door management module 25 of the system ECU 20 sends a control signal, commanding to send the request signal, to the door ECU 30 of the door 1. Accordingly, the sending control module 32 of the door ECU 30 of the door 1 controls the sending control unit 36 so that the sending control unit 36 modulates a low frequency band (LF) (approximately 130 kHz) carrier wave so as to transmit request information, thereby generating the request signal, provided with information, such as a door ID and the locked state of the door 1 and the like, and sends the generated request signal toward the outside of the vehicle by means of the LF antenna 14 in a periodic manner (Step #101).

The request signal is transmitted in a predetermined area in the vicinity of the vehicle, and when the user is within the predetermined area, the portable device S, carried by the user, can receive the request signal. When the request signal is received by the portable device S, the portable device S sends the response signal. An ultra high frequency band (UHF) (approximately 300 MHz) carrier wave is modulated so as to transmit response information, thereby generating the request signal provided with the user ID, memorized in the portable device S, and the door ID, obtained from the request signal.

The response signal is received by the UHF antenna 27, and the response signal, received by the UHF antenna 27, is sent from the receiving unit 28 to the system ECU 20 so that the response signal is obtained by the receiving control module 23. In the system ECU 20, the identification module 24 compares a memorized user ID and the user ID, obtained from the response signal. When both of the user IDs matches, the portable device S is identified (Steps #102 to #104).

When the portable device S is identified, the door management module 25 sends a lock allowance signal to the door ECU 30 of the door 1, which is identified by the door ID obtained from the response signal. Accordingly, the detection control module 33 of the door ECU 30 activates the unlock detection electrode 15 of the electrostatic capacitance unit 37 (Step #105).

In such a state, when the user inserts his/her hand into the clearance between the grip portion 2 of the door handle H and the outer panel 1P, a change of the electrostatic capacitance of the unlock detection electrode 15 is detected by the electrostatic capacitance measurement unit 37. In response to the detection of the change of the electrostatic capacitance, the lock control module 34 of the door ECU 30 sends an unlock control signal to the lock control unit 38. Accordingly, the lock control unit 38 controls the lock actuator 11A so that the lock mechanism 11 executes the unlocking operation (Steps #106 to #107).

[Lock Control Routine]

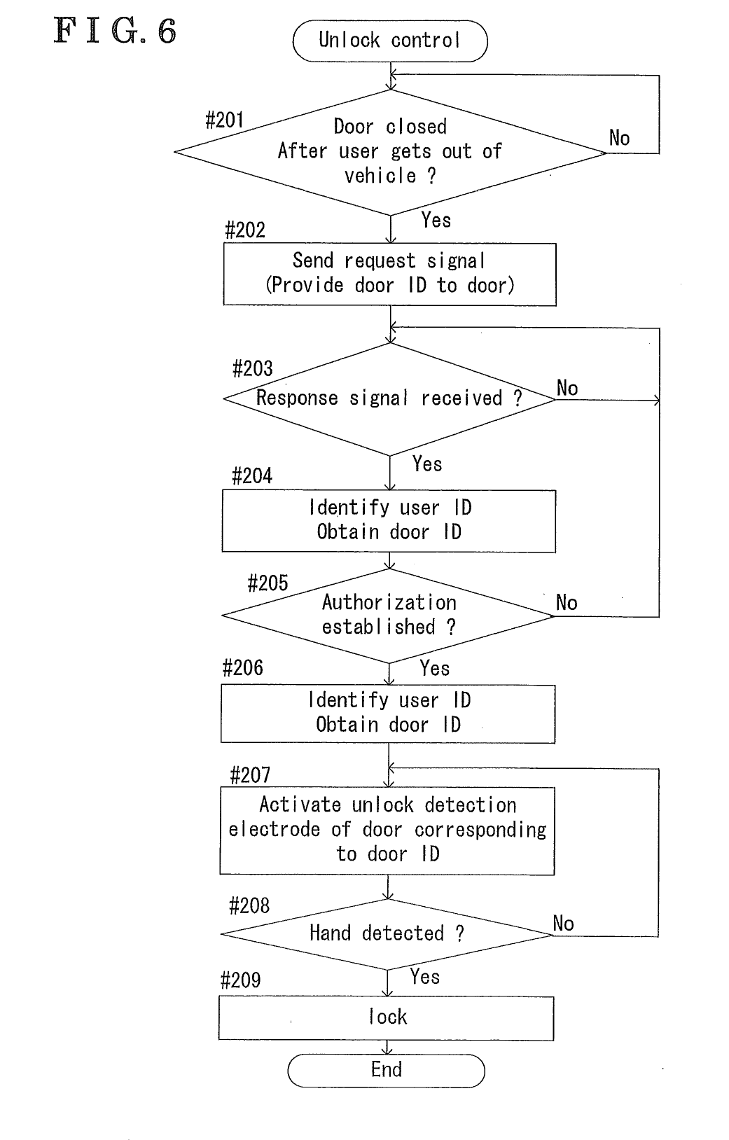

The lock control routine is illustrated in a flowchart shown FIG. 6. When it is detected, on the basis of the information outputted from the opening-and-closing detection switch 17 and the like, that the door 1 is opened and closed and that the user gets out of the vehicle, a control signal, commanding to send the request signal, is sent to the door ECU 30 of the door 1. Accordingly, the sending control module 32 of the door ECU 30 of each of the doors 1 controls the sending control unit 36 so that the sending control unit 36 modulates the low frequency band (LF) (approximately 130 kHz) carrier wave so as to transmit the request information, thereby generating the request signal, provided with information, such as a door ID and the unlocked state of the door 1 and the like, and sends the generated request signal toward the outside of the vehicle by means of the LF antenna 14 in a periodic manner (Steps #201 to #202).

Although it is not described as the configuration of the locking system, the locking system includes a detection system for detecting whether or not the user exists within the inside of the vehicle because there may be a case where the response signal in response to the request signal is sent by the portable device S, which exists at the inside of the vehicle. A process for detecting the existence of the user at the inside of the vehicle by the detection system is executed in Step #202. Thus, the position of the user may be appropriately determined.

The request signal is transmitted in a predetermined area in the vicinity of the vehicle, and when the user is within the predetermined area, the portable device S, carried by the user, can receive the request signal. When the request signal is received by the portable device S, the portable device S sends the response signal. The ultra high frequency band (UHF) (approximately 300 MHz) carrier wave is modulated so as to transmit the response information, thereby the request signal is provided with the user ID, memorized in the portable device S, and the door ID, obtained from the request signal.

The response signal is received by the UHF antenna 27, and the response signal, received by the UHF antenna 27, is sent from the receiving unit 28 to the system ECU 20 so that the response signal is obtained by the receiving control module 23. In the system ECU 20, the identification module 24 compares the memorized user ID and the user ID, obtained from the response signal. When both of the user IDs matches, the portable device S is identified (Steps #203 to #206).

When the portable device S is identified, the door management module 25 sends an unlock allowance signal to the door ECU 30 of the door 1, which is recognized by the door ID obtained from the response signal. Accordingly, the detection control module 33 of the door ECU 30 activates the lock detection electrode 16 of the electrostatic capacitance unit 37 (Step #207).

In such a state, when the user inserts his/her hand into the clearance between the grip portion 2 of the door handle H and the outer panel 1P, a change of the electrostatic capacitance of the unlock detection electrode 16 is detected by the electrostatic capacitance measurement unit 37. In response to the detection, the door ECU 30 inputs the information of the change of the electrostatic capacitance to the system ECU 20. The system ECU 20 then outputs locking commanding information to the door ECUs 30 of all the doors 1. Accordingly, the lock control module 34 of each of the doors 1 (the door 1, at which the hand of the user is detected, and the other doors 1) sends a lock control signal into the lock control unit 38. Accordingly, the lock control unit 38 controls the lock actuator 11A so that the lock mechanism 11 executes the locking operation (Step #208).

According to a known door handle apparatus, in which a sensor unit is arranged at a grip portion of a door handle, troublesome tasks such as, for example, inserting cables into an opening, formed at an outer panel, and connecting the inserted cables to other components by means of a connector may be required. However, according to the door handle apparatus of the embodiment, the detection unit D is arranged at the outer panel 1P (the inside portion of the door 1). Therefore, such troublesome tasks are not required. Further, the LF antenna 14, the unlock detection electrode 15 and the lock detection electrode 16 are accommodated in the case 13 of the detection unit D. Therefore, a plurality of antennas may be attached to the outer panel 1P as a unit (detection unit D), as a result, the antennas may not have to be attached separately.

The case 13 is made of resin, and the case 13 is arranged at a portion of the outer panel 1P where the slit 1S is formed. Therefore, a radio wave signal, outputted from the LF antenna 14, may not be shut off by the outer panel 1P and is transmitted toward the exterior of the vehicle. Further, the outer panel 1P may not interfere with the detection by means of the unlock detection electrode 15 and the lock detection electrode 16.

The width Ws of the case 13 (which corresponds to the width Ws of the slit 1S) in the upper-lower direction of the vehicle is set to be smaller than the width Wh of the grip portion 2 in the upper-lower direction of the vehicle. Further, the grip portion 2 is arranged so as to overlap the case 13 (which is arranged at the portion of the outer panel 1P corresponding to the slit 1S) in the horizontal direction of the vehicle. Therefore, the grip portion 2 obstructs a view of the slit 1S and the case 13 when the door handle H and the vicinity thereof are seen from the exterior of the vehicle, and it may become difficult to visually recognize the slit 1S and the case 13 from the exterior of the vehicle. Accordingly, even when a color the case 13 differs from a color of a coating of the outer panel 1P, the case 13 may not stand out visually, and an additional component or a special process for improving an outer appearance of the vicinity of the case 13 may not be required.

### Other Embodiment

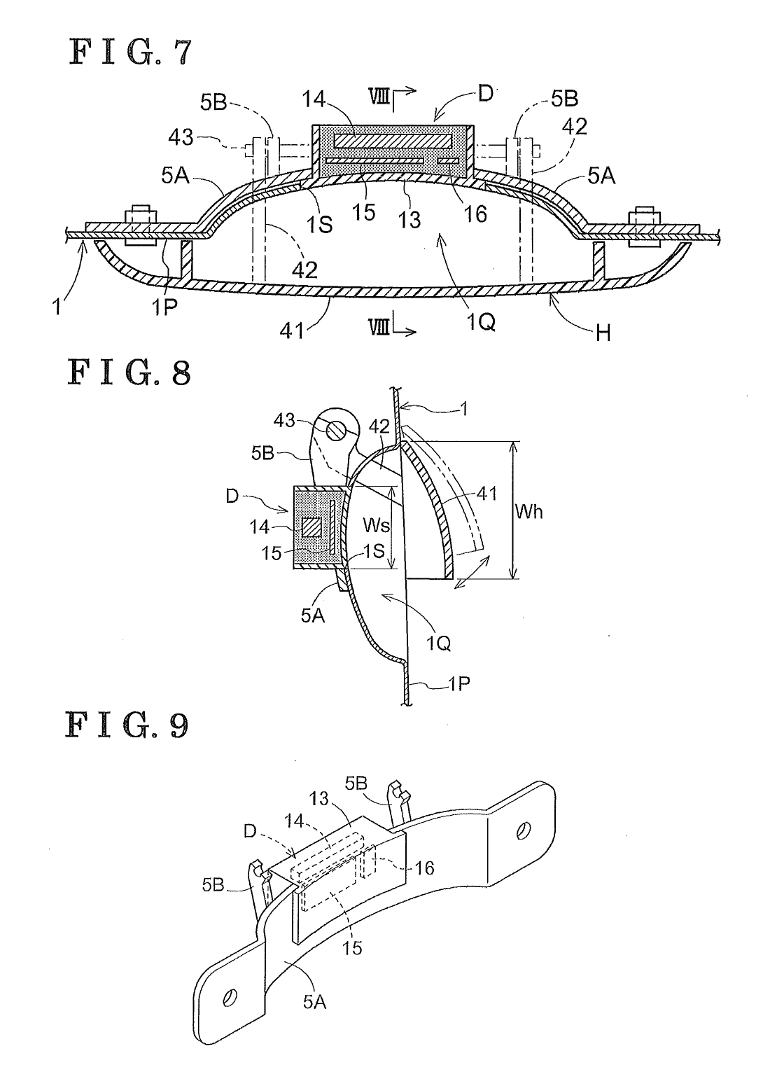

As illustrated in FIGS. 7 to 9, the door handle H, which is operated in a pulling manner, may be adapted. More specifically, a handle portion 41, which is operated in a pulling manner, is arranged at the outer panel 1P so as to overlap the recessed portion 1Q. A pair of pivot arms 42, formed at the handle portion 41, are pivotably supported at a support shaft 43, provided at the inside portion of the door 1. The support shaft 43 is connected to upper end portions of a pair of support arms 5B, which are formed at the strip-shaped sub frame 5A so as to protrude upwardly therefrom.

The sub frame 5A is formed so as to curve along a back surface of the recessed portion 1Q. A cutout portion is formed at an intermediate portion of the sub frame 5A. The case 13, made of resin, is fitted into the cutout portion of the sub frame 5A. Further, the slit 1S is formed at a portion of the recessed portion 1Q corresponding to the case 13. A portion of the case 13 is exposed to the exterior of the door 1 by means of the slit 1S.

The LF antenna 14, the unlock detection electrode 15 and the lock detection electrode 16 are accommodated in the case 13, and thereby the detection unit D is configured.

The width Ws of the slit 1S in the upper-lower direction of the vehicle is set to be smaller than the width Wh of the handle portion 41 in the upper-lower direction of the vehicle, and the handle portion 41 is arranged so as to cover the slit 1S in the horizontal direction of the vehicle. The width of the case 13 corresponds to the width Ws of the slit 1S, and the handle portion 41 is arranged so as to cover the case 13 in the horizontal direction of the vehicle. Therefore, the view of the case 13 is obstructed by means of the handle portion 41, and it may become difficult to visually recognize the case 13 due to the handle portion 41. Accordingly, an additional component or a special process for improving an outer appearance of the vicinity of the case 13 may not be required.

The embodiment is adaptable to a vehicle in general. The embodiment may be also adapted to a back door and the like.

According to the embodiment, a door handle apparatus for a vehicle includes the door handle H arranged at the outer surface of the outer panel 1P and releasing the latch mechanism 12 when the door handle H is manually operated, and the detection unit D arranged within the outer panel 1P so as to face the door handle H, the detection unit D including the electrode mechanism 15 and 16, whose electrostatic capacitance changes when a portion of a body of a user is inserted between the door handle H and the outer panel 1P, so that the unlocking operation or the locking operation is executed by means of the lock mechanism 11 on the basis of the change of the electrostatic capacitance, and including the LF antenna 14 sending a request signal for identifying the portable device S, to the portable device S, carried by the user.

Accordingly, the door handle H is arranged at the outer surface of the outer panel 1P and the detection unit D is arranged at the inner side of the outer panel 1P so as to face the door handle H. Therefore, compared to, for example, a configuration where a sensor unit is arranged at the door handle, drawbacks such as the complicated handling of the wires, may be avoided. Further, the detection unit D is arranged at the inner side of the outer panel 1P. Therefore, a function of detecting the hand of the user on the basis of the change of the electrostatic capacitance of the electrode mechanism, may be appropriately performed, and the request signal is sent from the antenna, provided to the detection unit D, to the portable device S, carried by the user, so that the locking of the door 1 may be released in response to the identification. Accordingly, the door handle apparatus for the vehicle, having the sensor unit at the door panel, is mounted on the vehicle in an easier manner.

According to the embodiment, the detection unit D is configured in a manner where the electrode mechanism 15 and 16 and the LF antenna 14 are accommodated in the case 13, and the case 13 is arranged at the slit 1S, formed at the outer panel 1P.

Accordingly, the change of electrostatic capacitance is detected through the slit 1S, formed at the door panel, and the request signal is sent through the slit 1S. Therefore, the door panel less influences the detection of the hand and the sending of the request signal.

According to the embodiment, the width Ws of the slit 1S is set to be smaller than the width Wh of the door handle H, and the door handle H is arranged so as to overlap longitudinal sides of the slit 1S.

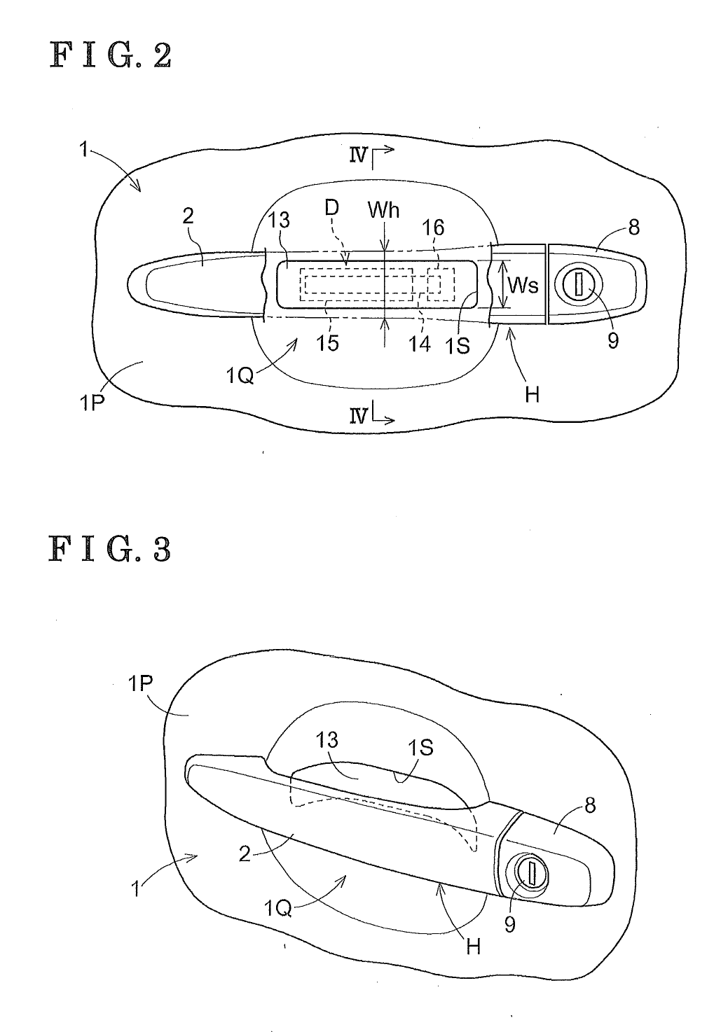

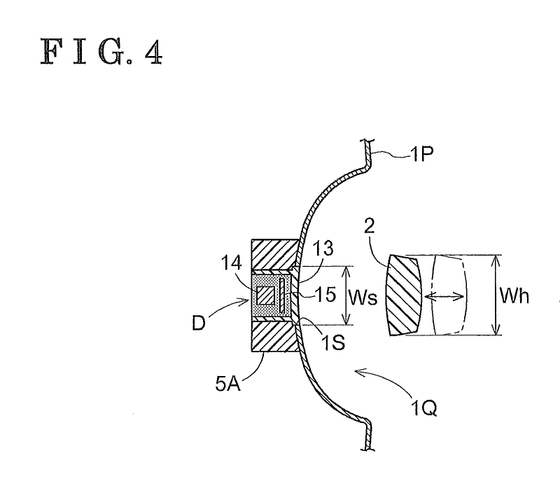

Accordingly, as illustrated in, for example, FIGS. 2 and 4, the width Ws of the slit 1S in the upper-lower direction of the vehicle is set to be smaller than the width Wh of the door handle H in the upper-lower direction of the vehicle. Therefore, the door handle H obstructs the view of the slit 1S, and the slit 1S may not be visually recognized from the exterior of the vehicle. Accordingly, an additional component or a special process for improving an outer appearance of the vicinity of the slit 1S may not be required.

According to the embodiment, the electrode mechanism 15 and 16 is configured by the unlock detection electrode 15 for executing the unlocking operation and the lock detection electrode 16 for executing the locking operation.

Accordingly, the unlocking operation and the locking operation are executed according to the unlock detection electrode 15 and the lock detection electrode, respectively.

According to the embodiment, the unlock detection electrode 15 and the lock detection electrode 16 are arranged in series with each other along a longitudinal direction of the vehicle.

According to the embodiment, the electrode mechanism 15 and 16 and the antenna 14 are accommodated in the case 13.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A door handle apparatus for a vehicle comprising:
a door handle arranged at an outer surface of an outer panel and releasing a latch mechanism when the door handle is manually operated; and
a detection unit arranged within the outer panel so as to face the door handle, the detection unit including an electrode mechanism, whose electrostatic capacitance changes when a portion of a body of a user is inserted between the door handle and the outer panel, so that an unlocking operation or a locking operation is executed by means of a lock mechanism on the basis of the change of the electrostatic capacitance, and including an antenna sending a request signal for identifying a portable device, to the portable device, carried by the user.

2. The door handle apparatus for the vehicle according to claim 1, wherein
the detection unit is configured in a manner where the electrode mechanism and the antenna are accommodated in a case, and wherein
the case is arranged at an opening, formed at the outer panel.

3. The door handle apparatus for the vehicle according to claim 2, wherein
a width of the opening is set to be smaller than a width of the door handle, and wherein the door handle is arranged so as to overlap longitudinal sides of the opening.

4. The door handle apparatus for the vehicle according to claim 1, wherein
the electrode mechanism is configured by an unlock detection electrode for executing the unlocking operation and a lock detection electrode for executing the locking operation.

5. The door handle apparatus for the vehicle according to claim 4, wherein
the unlock detection electrode and the lock detection electrode are arranged in series with each other along a longitudinal direction of the vehicle.

6. The door handle apparatus for the vehicle according to claim 2, wherein
the electrode mechanism and the antenna are accommodated in the case.
